(19) United States
(12) Patent Application Publication
(10) Pub. No.: US 2014/0078086 A1
(43) Pub. Date: Mar. 20, 2014

(54) AUGMENTED TOUCH CONTROL FOR HAND-HELD DEVICES

(71) Applicant: Marvell World Trade Ltd., St. Michael (BB)

(72) Inventors: J. Daren Bledsoe, Corvallis, OR (US); Steven M. Goss, Corvallis, OR (US); Gary D. Zimmerman, Garden Valley, ID (US); Mark D. Montierth, Meridian, ID (US); Gregory F. Carlson, Corvalis, OR (US); Phillip Salvatori, Salem, OR (US)

(73) Assignee: Marvell World Trade Ltd., St. Michael (BB)

(21) Appl. No.: 14/028,788

(22) Filed: Sep. 17, 2013

Related U.S. Application Data
(60) Provisional application No. 61/703,583, filed on Sep. 20, 2012.

(51) Int. Cl. G06F 3/041

(52) U.S. Cl. CPC G06F 3/041
USPC 345/173

(57) ABSTRACT

In various embodiments, the present disclosure describes hand-held devices with one or more touch-sensitive areas. The hand-held devices include a housing occupying each of a first plane, a second plane, and a third plane. A first exterior surface of the housing occupies the first plane and includes a first touch-sensitive area responsive to user touch. A second exterior surface of the housing occupies the second plane and includes a second touch-sensitive area responsive to user touch. A third exterior surface of the housing occupies the third plane and includes a display screen. A user interface module causes display of a user interface on the display screen and interprets at least one of (i) user touch of the first touch-sensitive area as a command to interact with the user interface or (ii) user touch of the second touch-sensitive area as a command to interact with the user interface.

### CROSS REFERENCE TO RELATED APPLICATIONS

This claims priority to U.S. Provisional Patent Application No. 61/703,583, filed Sep. 20, 2012, which is incorporated herein by reference.

### TECHNICAL FIELD

Embodiments of the present disclosure relate to the field of mobile computing devices, and more particularly to techniques, devices, and systems for augmented touch input for hand-held devices using non-display touch-sensitive surfaces.

### BACKGROUND

Conventional hand-held computing devices, such as smart phones, tablet computers, electronic readers, portable media players, and other similar devices, often include a touch-sensitive display screen. Such touch-sensitive display screens utilize built-in resistive or capacitive (or other) touch-sensitive technology, typically layered as a thin transparent coating over the display screen or integrated as part of the display screen itself. Additionally, mechanical buttons are often situated on the sides or tops of the hand-held device to enable additional user control of the device. Touch-sensitive display screens are popular, but there are some drawbacks. As such devices increase in size, using a single hand to both hold the phone and manipulate the touch-sensitive display screen becomes increasingly difficult. Also, a user touching the screen temporarily blocks a portion of the screen from view.

### SUMMARY

In various embodiments, the present disclosure describes hand-held devices with one or more touch-sensitive areas. The hand-held devices include a housing occupying each of a first plane, a second plane, and a third plane. A first exterior surface of the housing occupies the first plane and includes a first touch-sensitive area responsive to user touch. A second exterior surface of the housing occupies the second plane and includes a second touch-sensitive area responsive to user touch. A third exterior surface of the housing occupies the third plane and includes a display screen. A user interface module causes display of a user interface on the display screen and interprets at least one of (i) user touch of the first touch-sensitive area as a command to interact with the user interface or (ii) user touch of the second touch-sensitive area as a command to interact with the user interface.

In various embodiments, the present disclosure describes methods of operating a device with one or more touch-sensitive controls. The method includes detecting touch of a first touch-sensitive control that occupies a first plane of a housing of a hand-held device, detecting touch of a second touch-sensitive control that occupies a second plane of the housing of the hand-held device, and causing display of a user interface on a display screen occupying a third plane of the housing of the hand-held device. The method further includes interpreting at least one of (i) the touch of the first touch-sensitive control as a command to perform a user input function of the user interface displayed on the display screen or (ii) the touch of the second touch-sensitive control as a command to perform a user input function of the user interface displayed on the display screen.

In various embodiments, the present disclosure describes methods of operating a device with touch-sensitive areas on a back surface. The method includes causing display of a user interface on a touch-sensitive display screen that is disposed on a front of a housing of a hand-held device, and interpreting user touch on a first touch-sensitive area disposed on a back of the housing of the hand-held device as a first command to manipulate a cursor control of the user interface. The back of the hand-held device is opposite to the front of the hand-held device.

### BRIEF DESCRIPTION OF THE DRAWINGS

Embodiments of the present disclosure will be readily understood by the following detailed description in conjunction with the accompanying drawings. To facilitate this description, like reference numerals designate like structural elements. Embodiments herein are illustrated by way of example and not by way of limitation in the figures of the accompanying drawings.

FIGS. 1A-F illustrate perspective and side views of a hand-held device having touch-sensitive controls.

FIG. 2 illustrates a block diagram of an example hand-held device having touch-sensitive controls.

FIGS. 3A and 3B illustrate a toggle function based on touch of the touch-sensitive surfaces of a device.

FIGS. 4A and 4B illustrate techniques for controlling a cursor using a touch-pad disposed on the back-side exterior surface of a hand-held device.

FIG. 5 illustrates an example process for performing augmented touch control of a hand-held device.

### DETAILED DESCRIPTION

### Overview

Hand-held devices having touch-sensitive controls on the sides, top, bottom, and/or back of the device are described. Placing touch-sensitive controls on an exterior surface of the device other than the front surface—where the display screen is located—enables new user control functionality. For example, a user is able to hold the hand-held device in one hand and use the same hand to manipulate the touch-sensitive controls on the sides, top, bottom, and/or back to interact with a user interface displayed on the display screen. In one non-limiting example, a user scrolls through a list of menu items in a user interface displayed on the display screen by sliding his or her thumb along a touch-sensitive control located on the side of the phone, rather than using their other hand on the touch-screen to scroll. In another non-limiting example, a user selects interactive elements—such as icons—within the user interface using a touch pad located on a back-side exterior surface of the device. In yet another non-limiting example, a user playing a game on the device holds the device in both hands and manipulates the non-display touch-sensitive controls to control game elements without obscuring the user's view of the screen, thereby enhancing game play.

Having additional touch-sensitive controls also enables other functions according to various embodiments. Some embodiments of the present disclosure detect how a device is being held in a user's hand or hands by detecting that various portions of the touch-sensitive area(s) that are in contact with the user's hand or hands. Based on the position in which the device is being held, the device enables a different function, changes the display screen orientation, or takes other action.

Various device security features are enabled by having multiple touch-sensitive controls on a non-display surface. In one non-limiting example, a user may have a signature grip—a habitual manner in which the user typically grips the hand-held device. When the device determines that the touch-sensitive controls detect contact with a hand in a manner that is inconsistent with the user's signature grip, the device challenges the user for a password or other authentication. In another non-limiting example, the device accepts a series of touches (taps, swipes, holds) on multiple ones of the touch-sensitive areas in a predetermined pattern to unlock the device, or to enable the user to access a secure area or function of the hand-held device. Having multiple touch-sensitive surfaces increases the possible complexity of the touch input used to unlock the device, thereby making it more difficult to guess the correct touch pattern or use brute force methods to unlock the phone.

Although the hand-held devices described herein and illustrated in the figures often refer to a device that is generally small enough to fit into a user's hand, embodiments of the present disclosure are not limited to small devices. Other hand-held devices according to embodiments, such as tablet computers, media players, personal data assistants, larger mobile phones (e.g., “phablets”), also utilize touch-sensitive input as described herein.

These and other aspects are described in more detail below.

### Illustrative Embodiment

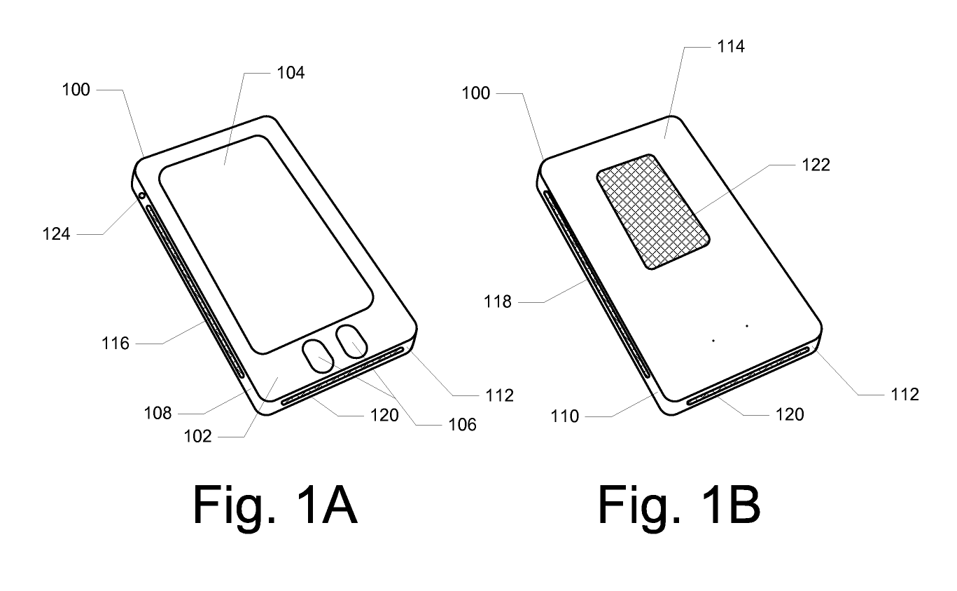

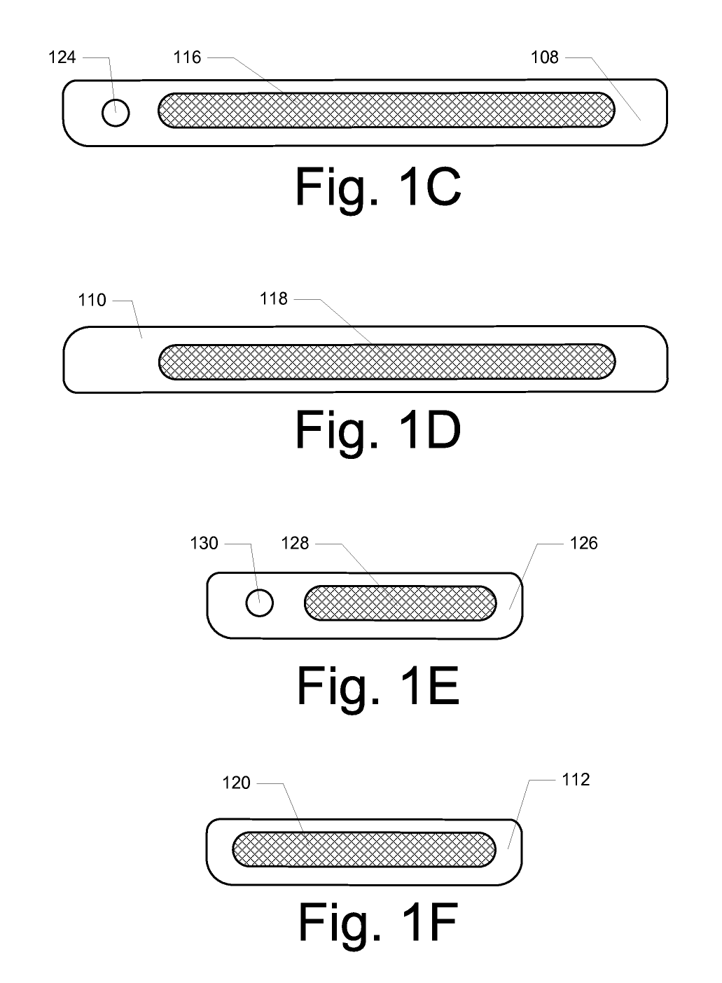

FIGS. 1A-F illustrate perspective and side views of a hand-held device 100 having touch-sensitive controls. The hand-held device 100 includes a front exterior surface 102, which includes a display screen 104 and controls 106. The display screen 104 is, in some embodiments, a touch-enabled display screen utilizing resistive, capacitive, optical, pressure-sensitive, micro switch, or other technologies to implement touch-sensitive capabilities. In embodiments, these technologies are layered in a transparent coating over the top of the display screen 104, although they may be incorporated within the display screen 104, placed underneath the display screen 104, and so forth. The controls 106 may be mechanically actuated buttons, touch-sensitive controls, or other.

The hand-held device 100 includes a left-side exterior surface 108, a right-side exterior surface 110, a bottom-side exterior surface 112, and a back-side exterior surface 114, each occupying a different plane (such that the hand-held device includes surfaces that occupy at least six planes). The hand-held device 100 also includes a top-side exterior surface 126 (visible in FIG. 1E). The hand-held device 100 includes various touch-sensitive controls, or touch-sensitive areas, on non-display surfaces of the hand-held device 100. The hand-held device 100 includes a left-side touch-sensitive area 116 disposed on left-side exterior surface 108, a right-side touch sensitive area 118 disposed on right-side exterior surface 110, and a bottom-side touch-sensitive area 120 disposed on the bottom-side exterior surface 112. The hand-held device 100 also includes a top-side touch-sensitive area 128 disposed on the top-side exterior surface 126.

Additionally, the hand-held device 100 includes a back-side touch-sensitive area 122 disposed on the back-side exterior surface 114. In the example shown in FIG. 1B, the back-side touch-sensitive area 122 is a touch pad, and the other touch-sensitive areas are strips (e.g., “touch strips”). But in embodiments, the back-side touch-sensitive area 122 may be a touch strip, or otherwise have a different shape, than a generally rectangular touch pad.

In one embodiment, each of the left-side exterior surface 108, the right-side exterior surface 110, the bottom-side exterior surface 112, the top-side exterior surface 126, and the back-side exterior surface 114 are surfaces of a housing of the hand-held device 100. In one embodiment, an outer cover is attachable to the housing to protect the hand-held device 100 and/or provide additional controls, including touch-sensitive controls, for the hand-held device 100 and/or to provide touch control of the touch-sensitive areas on the various surfaces of the housing. The outer cover may be electrically coupled to the hand-held device 100, such as via an input/output port that also provides power to the additional controls of the outer cover.

As used herein, a housing of the hand-held device 100 includes one or more components, such as plastic and/or metallic components, that house and protect the internal components of the hand-held device 100, such as the processor(s), the memory, radios (or other communication equipment), SIM card(s), and so forth. The housing includes an opening to enable the exterior surface of the display screen 104 to be visible and accessible. In some embodiments, one or more of various touch-sensitive areas present on the hand-held device 100 are included as part of one or more internal components, with the housing including openings to enable the touch-sensitive areas to be accessed by a user. In the same or different embodiments, one or more of the various touch-sensitive areas of the hand-held device 100 are integrated as part of the housing (e.g., as part of the external surfaces) and coupled to internal components (such as to a touch controller) located or housed within the housing.

As used herein, an outer cover is separate and distinct from the housing. An outer cover covers all or some of the housing of the hand-held device 100 and may include features that enable access to the various touch-sensitive areas and the display screen 104 (such as e.g., openings that allow direct contact to the various touch-sensitive areas) or material that enables touch input to be transmitted through the material to the various touch-sensitive areas), as well as including additional controls. The hand-held device 100 is usable without an outer cover, and removing an outer cover from the hand-held device does not expose the internal components to the outside environment, while removing the housing of the hand-held device 100 would expose the internal components to the outside environment, and the internal components of the hand-held device would not all be held in place without the housing.

FIG. 1C illustrates the left-side exterior surface 108 of hand-held device 100, which includes touch-sensitive area 116. The left-side exterior surface 108 also includes control 124, which may be a touch-sensitive control, a mechanically actuated button, or other control.

FIG. 1D illustrates the right-side exterior surface 110, which includes the right-side touch-sensitive area 118. FIG. 1E illustrates a top-side exterior surface 126, which includes the top-side touch-sensitive area 128 and control 130. Control 130 is, in various embodiments, a touch-sensitive control, a mechanically actuated button, or other control. FIG. 1F illustrates the bottom-side exterior surface 112, which includes bottom-side touch-sensitive area 120.

The various touch-sensitive areas and controls of the hand-held device 100 utilize resistive or capacitive touch-sensitive technology. In the same or different embodiments, various ones of the touch-sensitive areas utilize optical technology, including infrared or visible light optical sensors, which produces output signals responsive to detecting light and/or dark areas, or changes in light and dark areas, on the touch-sensitive area. In the same or different embodiments, the various touch-sensitive areas utilize pressure sensors to detect user touch or contact with other objects (such as other devices, a table, and so forth). In the same or different embodiments, the various touch-sensitive areas utilize micro-mechanical switches—which produce electric current responsive to the mechanical force applied to them, to enable the hand-held device 100 to detect contact with the user or with another object. Other touch-sensitive technologies may be employed without departing from the scope of embodiments.

The controls 106, the control 124, and/or the control 130 perform various functions, such as for example toggling some or all of the touch-sensitive areas of the hand-held device 100 on and off, turning the hand-held device 100 on or off, turning on or off the display screen 104, putting the hand-held device 100 into a sleep mode, launching a context-sensitive menu, causing display of a “home” screen of the user interface, launching a user search function, muting a speaker of the phone, waking the hand-held device 100 form a sleep mode, and so forth. In some embodiments, the control 124 is used in conjunction with the touch-sensitive areas of the hand-held device 100 to perform various user interface functions; for example it may be used as a “SHIFT” key when an on-screen keyboard is displayed on the display screen 104. Although FIGS. 1A, 1C, and 1E illustrate such controls only on the left-side exterior surface 108 and the top-side exterior surface 126, any one or more of the exterior surfaces, or none of the exterior surfaces, may include such controls according to various embodiments.

Although the hand-held device 100 illustrated in FIGS. 1A-F as having one touch-sensitive area for each of the left-side exterior surface, right-side exterior surface 110, bottom-side exterior surface 112, top-side exterior surface 126, and back-side exterior surface 114, other embodiments may have one or more external surfaces with no touch-sensitive areas. The same or different embodiments may have more than one touch-sensitive area on a single exterior surface. Non-limiting examples include two strips on the left-side exterior surface 108, a touch pad and a touch strip on the back-side exterior surface 114, a touch-sensitive button on one of the exterior surfaces, and so forth.

The touch-sensitive areas 116, 118, 120, 122, and 128 may have different shapes than those shown in FIGS. 1A-F. For example, a touch-sensitive area may have a circular shape, a rectangular shape, a square shape, a star shape, and so forth. A touch-sensitive area, such as the touch-sensitive area on the back-side exterior surface 114, may be curved or arced to track the range of movement of a user's digits when holding the hand-held device 100 in a typical way.

The locations of the touch-sensitive areas 116, 118, 120, 122, and 128 are selected, in some embodiments, to coincide with locations where users typically place their digits and palms on the hand-held device 100 while gripping it in their hands in one or more typical grip configurations, such as a one-handed vertical grip, a two-handed horizontal grip, and so forth. In one non-limiting example, the location of the back-side touch-sensitive area 122 is located nearer to the top-side exterior surface of the hand-held device 100, rather than the bottom-side exterior surface 112 of the hand-held device 100, because a user holding the hand-held device 100 in a one-handed vertical grip, typically grips the hand-held device 100 with his or her digits closer to the top of the hand-held device 100 than to the bottom. On the other hand, the back-side touch-sensitive area 122, or a different or additional touch-sensitive area, may be placed nearer to the bottom-side exterior surface 112 in order to detect that the user's palm touches the device, so as to—in one non-limiting example—distinguish between a user holding the hand-held device 100 in their palm from the user holding the hand-held device 100 with two hands. The placement, sizes, and shapes of the touch-sensitive areas on the hand-held device 100 may be varied without departing from the scope of embodiments.

### Example Computing Device

FIG. 2 illustrates a block diagram of an exemplary hand-held device having touch-sensitive controls. Various non-limiting examples of the hand-held device 100 include mobile phones (including smart phones, flip phones, feature phones, and so forth), tablet computers, portable game players, portable media players, personal data assistants, and the like.

In one example configuration, hand-held device 100 comprises one or more processor(s) 202 and memory 204. Hand-held device 100 also contains communication connection(s) 206 that allow communications with various devices, including various wireless and wired communications. Examples include cellular technologies such as Long Term Evolution (LTE), Code Division Multiple Access (CDMA), and Global Systems for Mobile Communications (GSM) technologies and so on. Further examples include local and personal area networks such as those described in IEEE 802.11 standards. The hand-held device 100 also includes one or more input devices 208, including various controls, such as the touch-sensitive areas 116, 118, 120, 122, and 128, along with other touch and non-touch controls such as controls 106, 124, and 130, coupled communicatively to the processor(s) 202 and memory 204. In addition, the display screen 104 may also be a touch-enabled display screen configured to provide input signals based on user touch, although it may not be.

The memory 204 stores program instructions that are loadable and executable on the processor(s) 202, as well as data generated during execution of, and/or usable in conjunction with, these programs. Memory 204 stores an operating system 212, a user interface module 214, one or more applications 216, and various system functions, such as an email function 218, a messaging function 220 (such as a simple message service (SMS) function or multimedia message service (MMS)), a phone function 222 (enabling the hand-held device 100 to place and receive telephone calls), a web browser 224, and a text input function 226. The text input function 226 causes, in conjunction with the user interface module 214, the display of on-screen keyboard, enabling a user to select text for input (such as into the email function 218 or messaging function 220, and so forth). One or more of the user interface module 214, the email function 218, the messaging function 220, the phone function 222, the web browser 224, and the text input function 226, as well as other functions not described herein, may be part of the operating system 212, although they may also be separate components.

A security module 228 enables various security functions of the hand-held device 100, such as for example challenging a user for credentials to unlock the hand-held device 100 when detecting, via touch-sensitive inputs of the input devices 208, that the hand-held device 100 is not held in a manner typical of the user, or when a user's typical or signature touch input style is not detected. A user's touch input style may be based on a user's style of swipes, holds, touches, taps, etc. A user's touch input style may include the user's typical or common mistakes in applying user input, such as often inputting a user input command pattern that the user interface module 214 is not programmed to interpret as a valid user interface command. A learning module 230 is configured to learn the user's typical style of use and to challenge the user when detecting deviations from this style.

The learning module 230 is configured to learn a known user's unique input characteristics, which can be distinguished from other user's input characteristics, for security or other purposes (such as to identify the known user and enable user-specific functions or settings, such as display brightness, background music, ring volume, and so forth). The learning module 230 is configured to walk the known user through certain actions in order to learn the user's input characteristics. This may include directing the user to draw characters or other symbols on the display screen, using for example their fingers or a stylus. The learning module 230 records the user's stroke flow, e.g., starting points, direction of strokes, time to complete the character, characteristics of the completed stroke, and/or additional details regarding the user character input. The learning module 230 directs the user to draw the characters or symbols multiple times in order to determine averages, variances, or other statistical data regarding the stroke flow. In the same or other embodiments, the learning module 230 may employ a signature learning function, which directs the user to sign their name one or more times (such as with a finger or stylus on the display screen). The user's stroke flow and timing are employed to learn the user's signature characteristics. In embodiments, the learning module 230 directs the user to draw free-form input and to capture user stroke flow based on the free-form input. In embodiments, the learning module 230 records the user's touch patterns on other touch-input surfaces (other than the display screen) to learn how the user typically holds the device and/or how the user interacts with the device, so as to identify the user for various security or non-security purposes.

In other embodiments, the security module 228 accepts user touch input via the touch-sensitive inputs of the input devices 208 to unlock the hand-held device 100, or to enable access to a secure function of the hand-held device 100, such as based on a determination that the hand-held device 100 is being gripped or touched in a manner consistent with the user's typical grip or touch patterns, and/or by otherwise accepting a series of pre-programmed taps, holds, and swipes on various touch-sensitive areas in a predetermined pattern (a form of password).

The hand-held device 100 also includes a touch controller 232 that detects touch input signals from the touch-sensitive areas of the input devices 208, and provides control signals to the user interface module 214. Motion detection device(s) 234 detect motion of the device and enable various functions, including user input functions in association with the user interface module 214, based on the motion of the hand-held device 100. The motion detection device(s) 234 include, in some embodiments, one or more of an accelerometer, a gyroscope, a global positioning system (GPS) receiver, and so forth.

The user interface module 214 is executable by the processor(s) 202 to cause display of a user interface on the display screen 104. The user interface module 214 accepts user touch inputs into various ones of the touch-sensitive areas of the input devices 208, and interprets those touch inputs as commands to enable or perform various user input functions. Such user input functions include launching or interacting with the application(s) 216, the email function 218, the messaging function 220, the phone function 222, web browser 224, the text input function 226, and other functions of the hand-held device 100, such as changing a ringer volume, launching a voice assistant function, and so forth.

### Functions Enabled by the Placement of Touch-Sensitive Areas on Exterior Surfaces

As noted above, placement of the touch-sensitive areas (e.g., 116, 118, 120, 122, and 128 of the touch-sensitive areas of the input devices 208) on the exterior surfaces of the hand-held device 100 enables user input functionality. Various examples include scrolling, magnifying/shrinking, zooming, bringing up menu items, selection of keys for text entry (including selection of shift, control, tab, and enter in addition to entry of alphabetic characters and numerals), on-screen navigation, changing volume, changing display screen brightness, launching or interacting with applications, launching or interacting with device features such as a camera application or a voice-enabled assistant application, and so forth.

In some embodiments, an operating system of the hand-held device 100 includes built-in user input functions associated with the various touch-sensitive areas of the hand-held device 100. In these embodiments, the user interface module 214 of the hand-held device 100 interprets the touch input detected from the touch-sensitive areas as commands to manipulate one or more user interface elements. Such user interface elements include application icons, ringer volume control widgets, system configuration menu items, context-sensitive menus, and so forth. In the same or different embodiments, application developers develop specialized input methodologies for the touch-sensitive controls. In one non-limiting example, a game developer programs the touch-sensitive areas to provide various game controls.

Some embodiments utilize the touch-sensitive areas to enable scrolling. In some non-limiting examples, dragging a digit (such as a finger) across the bottom-side touch-sensitive area 120 and/or the top-side touch-sensitive area is interpreted by the user interface module 214 to cause a scroll across a display page—such as across a web page, operating system screen, or application screen—from right to left, or left to right, depending on the direction of the digit drag, thereby making previously off-screen horizontal portions of the web page, operating system screen, or application screen viewable on the display screen 104. Conversely, a digit drag on one of the left-side touch-sensitive area 116 or the right-side touch-sensitive area 118 is interpreted by the user interface module 214 to cause a scroll up or down the display screen, depending on the direction of the digit drag thereby making previously off-screen vertical portions of the web page, operating system screen, or application screen viewable on the display screen 104.

In the same or different examples, turning the hand-held device 100 from a vertical hold position to a horizontal hold position (such as may be determined based on motion detected by the motion detection device(s) 234 or based on user contact with various ones of the touch-sensitive areas) may cause the display screen to rotate from the vertical to horizontal display orientation (or vice versa). In these examples, the scrolling functions of the bottom-side touch-sensitive area 120 and/or the top-side touch-sensitive area 128, along with the functions of the left-side touch-sensitive area 116 and/or the right-side touch-sensitive area, are reversed. Thus, while the hand-held device 100 is held in a horizontal position, a digit drag on the top-side touch-sensitive area 128 and/or the bottom-side touch-sensitive area 120 causes scrolling up and down, while digit drag on the left-side touch-sensitive area 116 and/or the right-side touch-sensitive area 118 causes scrolling left and right.

The interface module 214 distinguishes between touch input with one, two, three, and four digit drags or swipes and interprets the touch input differently depending on the number of digits being dragged. In one non-limiting example, a single digit drag is interpreted as a scroll function, while two digit drags is interpreted to launch an application. The user interface module 214 also interprets instances of user taps and holds on the touch-sensitive areas as commands to invoke various user input functions. The user interface module 214 also interprets simultaneous touch, drag, tap, or other user contact on different ones of the touch-sensitive areas as commands to invoke various user input functions.

In one non-limiting example, the user interface module 214 increases or decreases the on-screen magnification based on a two-digit drag, one on each of the left-side touch-sensitive area 116 and the right-side touch-sensitive area 118. In another non-limiting example, dragging two digits simultaneously on one of the touch-sensitive areas is interpreted as a magnification command. In yet another non-limiting example, tapping one or more of the touch-sensitive areas (e.g., single tap, double tap, triple tap, etc.) is interpreted by the user interface module 214 as a magnification command. Tapping on the top-side touch-sensitive area 128 may cause magnification to increase, while tapping on the bottom-side touch-sensitive area 120 may cause magnification to decrease.

The user interface module 214 is configured to distinguish between right and left-handed holds of the hand-held device 100, such that certain input function patterns are reversed or mirrored, based on whether the user is holding the device in their left hand or in their right hand. The user interface module 214 detects whether the left or right hand is used to hold the device, and enables various user input function patterns based on this determination. In some embodiments, holding the device in the left hand may reverse or mirror at least some user input functions of the touch-sensitive areas. In some embodiments, some or all input functions may be changed based on the hand in which the device is held, and such changes may be mirrored, reversed, or changed in some other way. In one example, when the device is held in a certain position, the left-side touch-sensitive area 116 and right-side touch-sensitive area 118 have their input functions reversed based on the hand that is being used to hold the device, while the bottom-side touch-sensitive area 120 and the top-side touch-sensitive area 128 do not have their input functions reversed. In a different hold position (such as in a landscape hold position), the user interface module 214 reverses the input functions of the bottom-side touch-sensitive area 120 and the top-side touch-sensitive area 128, but not the left-side touch-sensitive area 116 and right-side touch-sensitive area 118, depending on detection of the hand being used to hold the hand-held device 100. In other embodiments, the user interface module 214 provides a static configuration option that enables the user to set the device to a left-handed or to a right-handed configuration, which establishes the input functions applied to the various touch-sensitive areas. In another example, the user interface module 214 rotates the input functions as the device as the device is physically rotated, such that the touch-sensitive area that faces, for example, upwards relative to the direction of gravitational force will take on a particular user input function, regardless of which particular touch-sensitive area is facing upwards. Other examples are possible without departing from the scope of embodiments.

In some embodiments, the user interface module 214 interprets consecutive user taps—such as single, double, triple, or other number of consecutive taps within a certain predetermined period of time (such as less than 1 second, 1.5 seconds, 2 seconds or other time period)—on one of the touch-sensitive surfaces as a command to reduce or increase magnification or zoom. In one non-limiting example, a double tap on the left-side touch-sensitive area 116 causes an increase level of zoom, while double-tapping on the right-side touch-sensitive area 118 causes a decrease level of zoom. Further double-taps on the left-side touch-sensitive area 116 causes further increased zoom, while further double-taps on the right-side touch-sensitive area 118 causes further decrease in the level of zoom. In another non-limiting embodiment, a double-tap on the left-side touch-sensitive area 116 causes a first level of zoom, while a triple-tap on the left-side touch-sensitive area 116 causes a second level of zoom. In some embodiments, the user interface module 214 interprets simultaneous user taps—such as single, double, triple, or other number of simultaneous taps within a certain predetermined period of time—on one or more of the touch-sensitive surfaces as a command to reduce or increase magnification or zoom. Thus, in one non-limiting example, three digits simultaneously tapped on the top-side touch-sensitive area 128 causes a level of zoom to increase, while two digits tapped simultaneously on the bottom-side touch-sensitive area 120 causes the level of zoom to be decreased. Other examples are possible without departing from the scope of embodiments.

Also, various combinations of user input modalities are utilized in various embodiments. For example, a double-tap with three fingers (tapping all three fingers at the same time) may cause a certain function to be performed.

In some embodiments, touch of one of the touch-sensitive areas is interpreted as a command to select or activate a user interface element displayed on the user interface. For example, scrolling through a menu list displayed on the display screen 104 may cause items within the list to be highlighted, or otherwise identified as selectable. Tapping on one or more of the touch-sensitive areas may cause the highlighted menu item to be selected or launched. In one non-limiting example, the right-side touch-sensitive area 118 is activated to scroll through a menu based on digit drag, while tapping on the right-side touch-sensitive area 118 is interpreted as selection of the currently highlighted item in the menu.

In some embodiments, touch of one or more of the touch-sensitive areas causes a menu to be displayed. The menu may be a context-sensitive menu. In one non-limiting example, a tap on the top-side touch-sensitive area 128 is interpreted as a command to bring up a context-sensitive menu, which may be scrolled through using digit drag or swipe as described elsewhere within this Detailed Description. In another non-limiting example, three consecutive digit drags on the bottom-side touch-sensitive area 120 within a certain predetermined period of time (such as less than 1 second, 1.5 seconds, 2 seconds or other time period) is interpreted by the user interface module 214 as a command to bring up a menu, such as a context-sensitive or other menu.

In some embodiments, the user interface module 214 interprets touch input detected from various ones of the touch-sensitive areas of the hand-held device 100 as commands to enable various other touch-enabled commands. In the same or different embodiments, touch input detected from various ones of the touch-sensitive areas of the hand-held device 100 are interpreted to disable various touch-enabled commands. In one non-limiting example of a touch-command being enabled by touch input, a user simultaneously touching the left-side touch-sensitive area 116, the right-side touch-sensitive area 118, and the bottom-side touch-sensitive area 120 enables the back-side touch-sensitive area 122 to control cursor input on the device. In one non-limiting example of touch input disabling a command, prolonged user touch of both the left-side touch-sensitive area 116 and the right-side touch-sensitive area 118 (such as for longer than five seconds, or other time period) disables a touch command that results from simultaneous digit drag on the left-side touch-sensitive area 116 and the right-side touch-sensitive area 118. Disabling of the digit drag input prevents inadvertently causing the display to zoom in or out or to scroll (or perform some other function) based on slight slipping or movement of the hand-held device 100 in his or her hand.

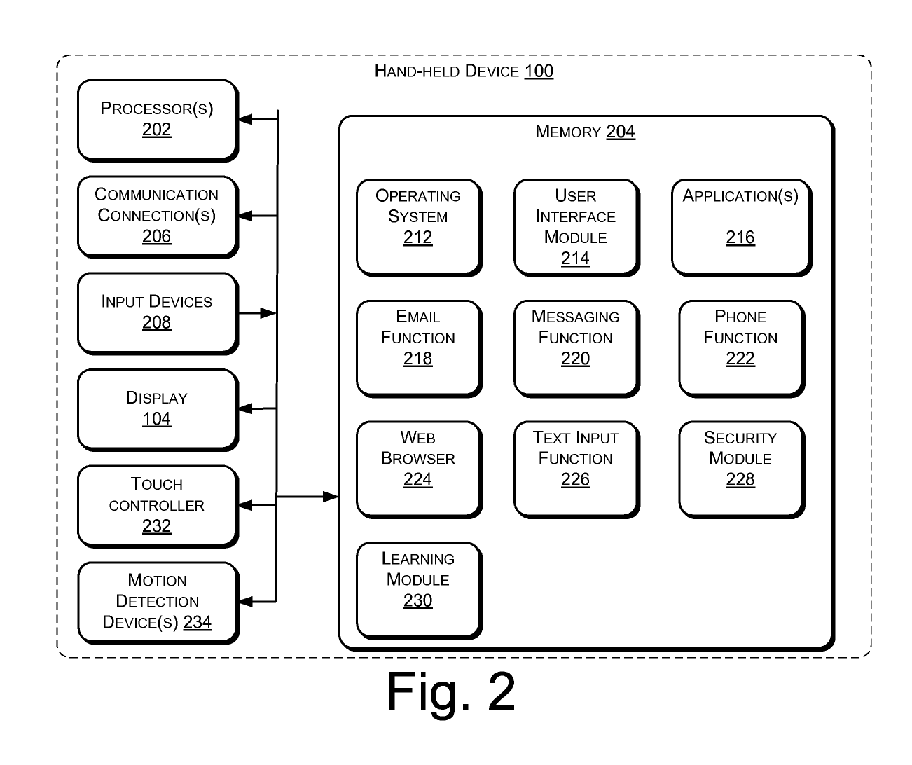

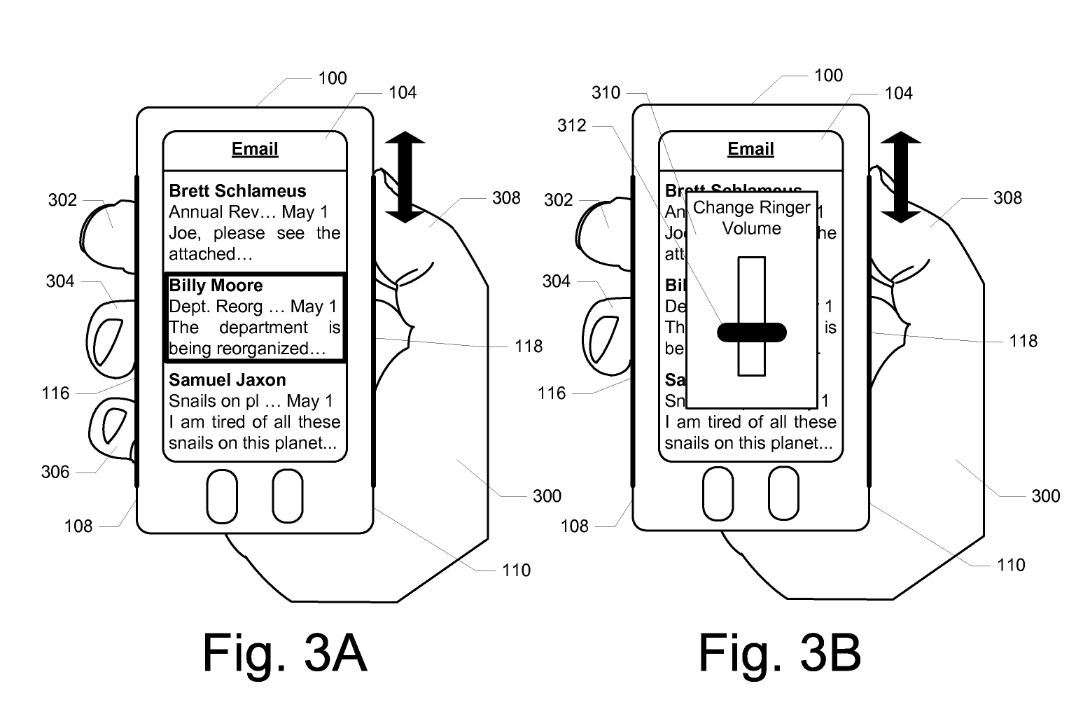

In some embodiments disabling or enabling a function of the hand-held device 100, including a touch command function, is based on determining how the hand-held device 100 is being held in a user's hand. In one non-limiting example, determining that the hand-held device 100 is being held in the user's palm is based on identifying contact points with various portions of the touch-sensitive areas, such as those that are commonly touched when the device is in the palm. In one non-limiting example, detecting simultaneous touch on particular portions of the left-side touch-sensitive area 116, the right-side touch-sensitive area 118, and the back-side touch-sensitive area 122, but no touch on the bottom-side touch-sensitive area 120 or the top-side touch-sensitive area 128, is interpreted by the user interface module 214 to mean that the hand-held device 100 is being held in a vertical position in a user's hand. Contact patterns indicating this and other hold positions (such as two-handed horizontal hold, single-handed horizontal hold) may be pre-programmed into the hand-held device 100 or learned over time. The contact patterns indicating various hold positions may be customized to a particular user's habits. The user interface module 214 also, in some embodiments, utilizes the motion detection of the motion detection device(s) 234, either alone or in conjunction with user touch input, to determine the position in which the hand-held device 100 is being held. A particular example of these embodiments is described in more detail below with respect to FIGS. 3A and 3B.

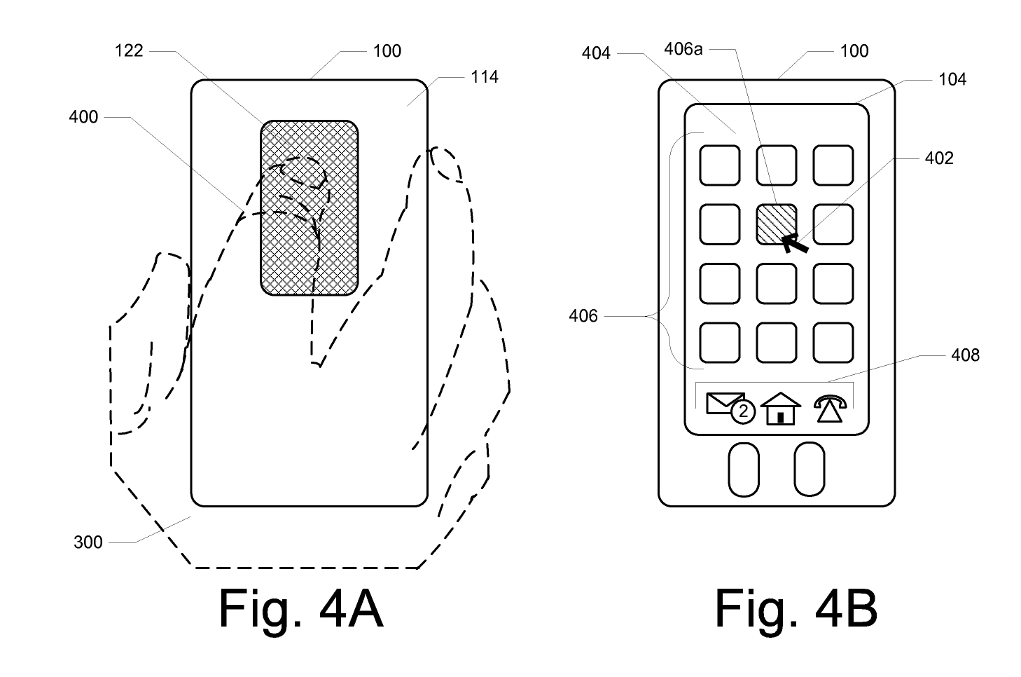

In some embodiments, the back-side touch-sensitive area 122 is a track pad or touch pad that controls a mouse-type or other cursor control displayed on the user interface. User manipulation of the touch pad or track pad causes display and positioning of a cursor or other pointer on the user interface screen that corresponds to a location on the touch pad or track pad that the user is touching. In one non-limiting example, digit movement on the back-side touch-sensitive area 122 causes the cursor control to move around the user interface, while tap input (such as single tap, double tap, and so forth) on the back-side touch-sensitive area 122 (or other touch-sensitive area) is interpreted as a command to select an interactive element of the user interface. In other embodiments, user touch input on the back-side touch-sensitive area 122 causes the user interface module 214 to cause various interactive elements within the user interface to be highlighted or otherwise changed in appearance, thereby indicating that further user input activates the interactive element. In one non-limiting example, the user manipulates the back-side touch-sensitive area 122 to cause a certain application icon to be highlighted, and then taps on the back-side touch-sensitive area 122 once to cause the application associated with the application icon to launch. A particular example of these embodiments is described in more detail below with respect to FIGS. 4A and 4B.

Touch commands are programmable by the user. For example, the user interface module 214 is pre-programmed with various touch-enabled commands (touches, digit drags, taps, and so forth). But the presence of multiple touch-sensitive areas on the hand-held device 100 enables many different patterns of user interaction, some of which are not pre-programmed on the user interface module 214. Thus, in some embodiments, the user is enabled to program new touch-enabled commands to perform various user interface functions. In one non-limiting example, a user programs a certain pattern of taps and digit drags that cause the user interface module 214 to launch a particular one of the application(s) 216.

Touch input via the various touch-sensitive areas can be used to enable text entry via the user interface module 214 and the text input function 226. In conventional hand-held devices, text entry is typically accomplished via an on-screen keyboard. In some embodiments of the present disclosure, the user interface module 214 and/or the text input function 226 enable the various touch-enabled areas of the hand-held device 100 to select text input while an on-screen keyboard is displayed on the display screen 104. In one non-limiting example, a touch-pad embodiment of the back-side touch-sensitive area 122 controls selection of the characters, numerals, punctuation marks, emoticons, or other characters available from the on-screen keyboard. In other non-limiting examples, touch input from one or more of the touch-sensitive areas causes a toggle to a different on-screen keyboard (such as from lower-case to upper-case views of the keyboard, switch to numeral view, switch to punctuation view, and so forth). In some embodiments, ones of the touch-sensitive areas are enabled to allow the user to enter a tab key input, a shift key input, a control key input, a space input, a period input, a comma input, via tapping, swiping, or performing other touch on a touch-sensitive area of the hand-held device 100. In one non-limiting example, a shift-key input is enabled by the user pressing and holding a digit against a certain portion of the left-side touch-sensitive area 116 to cause the characters shown in the on-screen keyboard to be temporarily shifted to all-caps, such that selection of the characters via the back-side touch-sensitive area 122 or via the touch-screen display screen 104 causes the capitalized versions of those characters to be input. The on-screen keyboard reverts to lower-case upon release of the user's digit from the certain portion.

The user interface module 214 determines from the back-side touch-sensitive area 122, or from other or additional ones of the touch-sensitive areas, whether the hand-held device 100 is being held by a user's right hand or left hand. The user interface module 214 then alters various user interface functions, such as the functions of the various touch-sensitive areas, depending on the hand in which the hand-held device 100 is being held. For example, responsive to determining which hand the user is holding the hand-held device 100 in, the user interface module 214 in conjunction with the text input function 226, changes a location on the display screen 104 on which an on-screen keyboard is displayed, thereby enabling either right-handed or left-handed touch-screen keyboard entry modes based on the hand placed on the back-side exterior surface 114 of the hand-held device 100.

The touch controller 232 and/or the user interface module 214 of the hand-held device 100, in some embodiments, enables other functions based on the touch-sensitive areas of the hand-held device 100. For example, where one or more of the touch-sensitive areas of the hand-held device 100 utilize optical technology to detect touch, the touch controller 232 is capable of determining from the optical output of the touch-sensitive areas that the hand-held device is placed on a flat surface, such as a table or stand, and adjust the display of the user interface accordingly. For example, where the hand-held device 100 is determined by the touch controller 232 or the user interface module 214 to be placed on a flat surface, an on-screen keyboard may be adjusted to enable two-handed touch-screen typing directly onto the touch-enabled display screen 104. Being placed on a flat surface such as a table is distinguishable from being held in a user's hand based on a percentage of the back-side touch-sensitive surface 122 detecting contact (for example 100% of the back-side touch-sensitive area 122 being covered indicates placement of the hand-held device 100 on a flat surface, while 80% or less coverage indicates that the hand-held device 100 is being held by a user), based on detected pattern of touch (straight lines indicating flat surface placement while irregular, hand, or digit-shaped touch patterns indicating that the hand-held device 100 is being held in a user's hand), or based on other factors, such as detected infrared intensity (indicating temperature of the thing in contact with the hand-held device, where relatively higher temperatures indicate user touch).

In some embodiments, the touch-sensitive areas may detect how tightly the hand-held device 100 is being gripped, and adjust one or more user interface functions accordingly. For example, one or more of the touch-sensitive areas utilize pressure sensors, and detect grip tightness based on sensed pressure levels. In one non-limiting embodiment, the user interface module 214 adjusts a selection of audio being played on a speaker of the hand-held device 100 to play more calming sounds or music when the hand-held device 100 is gripped tightly, such as based on detecting that pressure applied by the user's hand to the touch-sensitive areas of the hand-held device 100 exceeds a predetermined threshold pressure.

One or more of the various touch-sensitive areas—or particular areas of the touch-sensitive controls—are textured, in some embodiments, to enable the user to easily locate the touch-sensitive areas. In these or other embodiments, the particular areas of the touch-sensitive controls have specialized functions. The user interface module 214 is configured to interpret user touch on a particular area of the touch-sensitive controls as commands to perform a particular function that is different than the functions performed by the user interface module 214 responsive to touching other areas of the same touch-sensitive controls. In various non-limiting examples, a particular area of the left-side touch-sensitive area 116 is both textured and the user interface module 214 is configured interpret touch of the particular, textured area of the left-side touch-sensitive area 116 as a command to toggle another touch-sensitive control, mute a microphone of the hand-held device 100, launch an application, launch a camera function of the hand-held device 100, select an item currently coinciding with a cursor control (such as may be controlled by the back-side touch-sensitive area 122), and so forth.

### Illustrative User Interface Functions

FIGS. 3A and 3B illustrate a toggle function based on touch of the touch-sensitive surfaces of a device. A user holds hand-held device 100 in their hand 300. In the hold configuration shown in FIG. 3A, the user holds the hand-held device 100 with three digits—digits 302, 304, and 306—placed on a left-side touch-sensitive area 116 (denoted in FIGS. 3A and 3B by a thick line) on the left-side exterior surface 108 of the hand-held device 100. The user interface module 214 of the hand-held device 100 interprets the three digits held on the left-side touch-sensitive area 116 as enabling a scroll function of the right-side touch-sensitive area 118 (denoted in FIGS. 3A and 3B by a thick line) on the right-side exterior surface 110. Thus, the user interface module 214 interprets the user moving his or her thumb 308 up and down (denoted in FIGS. 3A and 3B by the black arrow) on the right-side touch-sensitive area 118 as a scroll through the emails displayed on the display screen 104. Swiping the thumb 308 down may cause scrolling down through the emails to make emails lower down in the list to be viewable on the display screen 104. Also, scrolling up and down using the thumb 308 may cause one of the emails to be highlighted or otherwise indicated as having user input focus (denoted in FIG. 3A as a box around the email from Billy Moore). Thus, in one particular example, a single-tap on the back-side user touch-sensitive area 122 (or other touch-sensitive area or other control) causes the user interface module 214 to open up the highlighted email and display more details of that email, including a full text of the email.

In the hold configuration shown in FIG. 3B, the user holds the hand-held device 100 with just two digits—digits 302 and 304—placed on a left-side touch-sensitive area 116 on the left-side exterior surface 108 of the hand-held device 100. The user interface module 214 of the hand-held device 100 interprets the two digits held on the left-side touch-sensitive area 116 as enabling a ringer volume control function of the right-side touch-sensitive area 118 on the right-side exterior surface 110. Responsive to detecting just two digits on the left-side touch-sensitive area 116, the user interface module 214 causes display of the “Change Ringer Volume” control 310. And the user interface module 214 interprets the user moving his or her thumb 308 up and down on the right-side touch-sensitive area 118 as a command to move the bar 312 up and down on the “Change Ringer Volume” control 310 to adjust a ringer volume of the hand-held device 100.

FIGS. 4A and 4B illustrate cursor control using a touch-pad disposed on the back-side exterior surface of a hand-held device. As shown in FIG. 4A, the user holds the hand-held device 100 with the back-side exterior surface 114 in the palm of their hand 300. The user manipulates the back-side touch-sensitive surface 122 with digit 400. The user interface module 214 interprets the user touch input onto the back-side touch-sensitive surface 122 as commands to control a cursor 402, as shown within the user interface 404 displayed on the display screen 104 of the hand-held device 100. The user interface 404 includes various interactive elements, such as application icons 406 and system icons 408. The application icons are selectable via the user interface 404 to launch ones of the application(s) 216, and the system icons are selectable to launch various system functions, such as the email function 218 and the phone function 222.

As the user hovers the cursor 402 over ones of the application icons 406 or the system icons 408, the user interface module 214 interprets further user touch input, such as a tap on the back-side touch-sensitive area 122, or touch input received from one of the other touch-sensitive areas of the hand-held device 100, as a selection of the ones of the icons 406 or 408 coinciding with the cursor 402 (in FIG. 4B, icon 406a coincides with the cursor 402). Alternatively, or in addition, the user interface module 214 causes one of the icons being hovered over, and thus primed for selection, to be highlighted within the user interface 404. In the particular example illustrated in FIG. 4B, application icon 406a is shown with a changed appearance (relative to the other icons 406). In embodiments where the cursor 402 is not displayed within the user interface 404, the user receives visual feedback from the manipulation of the back-side touch-sensitive area 122 based on the highlighting of icons within the user interface 404. Thus, the cursor 402 is not utilized by all embodiments.

Furthermore, the user interface module 214 of the hand-held device 100—according to some embodiments—receives touch input directly from the display screen 104, such as where the display screen 104 is a touch-sensitive display screen. In these embodiments, the user interface module 214 may disable or suppress control of the user interface 404 using the back-side touch-sensitive area 122 based on detecting touch input from the display screen 104, so as to give primacy to the touch-screen input. In these embodiments, detecting touch input from the display screen 104 results in the user interface module 214 disabling display of the cursor 402 and/or disabling display of highlighting to identify icons within the user interface 404 that are primed for selection. Alternatively or in addition, the user interface module 214 causes the display of the cursor 402 and/or the highlighting of a current one of icons 406 or 408 that is primed for selection based on detecting touch on the back-side touch-sensitive area 122, possibly in conjunction with touch on other ones of the touch-sensitive areas.

### Interaction Between Devices Using Touch-Sensitive Controls

Depending on the configuration and type of touch-sensitive areas placed on the hand-held device 100, the touch-sensitive areas are usable for communication between two hand-held devices 100 or between the hand-held device 100 and another type of device, such as a pad, cradle, or docking station. For example, one or more of the touch-sensitive areas may utilize optical technology to detect touch. When such a touch-sensitive area of the hand-held device 100 is placed into contact with a another device, the touch controller 232 enables communication between the hand-held device 100 and the other device using optical signaling. In one non-limiting example, the back-side touch-sensitive area 122 utilizes optical sensors to detect touch (e.g., by detecting areas of light and dark); the back-side touch-sensitive area 122 includes one or more optical transmitters (e.g., a light source that emits infrared or visible light). The back-side touch-sensitive area 122 is configured to transmit optical signals via the optical transmitter and to receive optical signals via the optical sensors. Two hand-held devices 100 may be placed back-to-back, or the hand-held device 100 may be placed onto a device with a specialized surface that is configured to send and receive optical signals, or into a docking station or pad that is configured to send and receive optical signals, in order to transmit signals between the devices.

Such device-to-device communication enables various applications, such as flashing a bar code, including a matrix barcode, or sending other optical signal to enable a user to check in for a flight at the airport, purchase an item at a store, send and receive email, and so forth. The two devices may engage in a hand-shake protocol to enable transmission. In other embodiments, the two devices may be configured to enable another type of communication, such as a personal area networks (PAN), wireless local area networks (such as those described in IEEE 802.11 standards), or other wired or wireless connection upon successfully completing a handshake protocol using the touch-sensitive area. The user interface module 214 may prompt the user to authorize the hand-held device 100 to communicate with the other device via the touch-sensitive areas, including transmission or reception of data, files, messages, etc. or authorization to establish a separate wired or wireless connection between the two devices.

### Example Processes

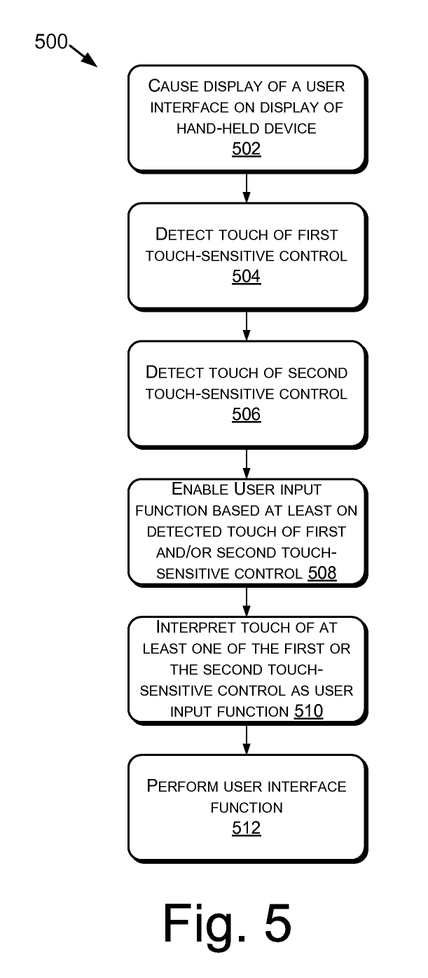

FIG. 5 illustrates an example process 500 for performing augmented touch control of a hand-held device. At 502, a user interface module, such as the user interface module 214, causes display of a user interface on a display screen of a hand-held device. The user interface includes one or more interactive elements, such as application icon, system function icons, menus, and so forth. The display screen may be a touch-sensitive display screen that provides user touch input to manipulate the interactive elements via the user interface module.

At 504, the user interface module detects touch of a first touch-sensitive control of the hand-held device. At 506, the user interface module detects touch of a second touch-sensitive control of the hand-held device. The touch-sensitive controls of the hand-held device are non-display controls disposed on exterior surfaces of the hand-held device.

At 508, the user interface module enables a user input function based at least on the detected touch of the first and/or second touch-sensitive controls. Enabling the user input function is based, in various embodiments, on determining from the touch input how the hand-held device is being held, the number of user digits placed on one or more of the touch-sensitive controls, and so forth. Enabling the user input function is based, in various embodiments, on the manner of the touch input detected on the touch-sensitive controls, including taps, holds, swipes, and so forth. This includes determining a number of consecutive swipes, taps, and holds on one or more of the touch-sensitive controls and/or a number of simultaneous swipes, taps, and holds on one or more of the touch-sensitive controls. Determining that two or more user touches are consecutive touches includes determining that the touches are detected within a predetermined period of time of one another, such as within 1.5 seconds of on one another, between 0.3 seconds and 1.2 seconds of one another, or based on some other time period. Similarly, determining that two or more user touches are simultaneous touches is based on receiving the multiple touches within a predetermined period of time, such as less than 0.2 seconds of one another, less than 0.1 seconds of one another, and so forth.

At 510, the user interface module interprets the touch of at least the first and/or second touch-sensitive areas as the user input function enabled at 508. As with the enabling of the user input function at 508, interpreting the touch input as a command to perform the user input function is based, in various embodiments, on determining from the touch input how the hand-held device is being held, the number of user digits placed on one or more of the touch-sensitive controls, and so forth. Enabling the user input function is based, in various embodiments, on the manner of the touch input detected on the touch-sensitive controls, including taps, holds, swipes, and so forth. This includes determining a number of consecutive swipes, taps, and holds on one or more of the touch-sensitive controls and/or a number of simultaneous swipes, taps, and holds on one or more of the touch-sensitive controls. Determining that two or more user touches are consecutive touches includes determining that the touches are detected within a predetermined period of time of one another, such as within 1.5 seconds of on one another, between 0.3 seconds and 1.2 seconds of one another, or based on some other time period. Similarly, determining that two or more user touches are simultaneous touches is based on receiving the multiple touches within a predetermined period of time, such as less than 0.2 seconds of one another, less than 0.1 seconds of one another, and so forth.

At 512, the user interface module performs the user interface function associated with the interpreted command. This includes adjusting the display of the user interface based on the touch of the first and/or second touch-sensitive controls. Adjusting the display includes, in various embodiments, changing an orientation view of the user interface (such as from horizontal view to vertical view and vice versa). Adjusting the display includes, in various other embodiments, displaying a new user interface control (such as a ringer volume control, brightness control, and the like), displaying a cursor control within the user interface, highlighting an interactive element of the user interface having particular user interface focus, and so forth. Other user interface functions include scrolling within the user interface, scrolling within a user interface control, scrolling within a menu, scrolling within an application screen, scrolling within a web browser screen, and so forth. The user interface functions include launching an application or system function (such as email, phone, messaging, and so forth). The user interface function includes interacting with an application, entering text, selection of an interactive element of the user interface, unlocking the hand-held device, putting the hand-held device to sleep, waking the hand-held device, and so forth. Embodiments are not limited to any particular user input function or functions.

### Computer-Readable Media

Depending on the configuration and type of computing system used, memory 204 may include volatile memory (such as random access memory (RAM)) and/or non-volatile memory (such as read-only memory (ROM), flash memory, etc.). Memory 204 may also include additional removable storage and/or non-removable storage including, but not limited to, flash memory, magnetic storage, optical storage, and/or tape storage that may provide non-volatile storage of computer readable instructions, data structures, program modules, and other data.

Memory 204 is an example of computer-readable media. Computer-readable media includes at least two types of computer-readable media, namely computer-readable storage media and communications media.

Computer storage media includes volatile and non-volatile, removable and non-removable media implemented in any method or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer-readable instructions, data structures, program modules, or other data in a modulated data signal, such as a carrier wave, or other transmission mechanism. As defined herein, computer storage media does not include communication media.

### CONCLUSION

Various operations are described as multiple discrete operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments. Operations of process 500 can be suitably combined and may comport with techniques and/or configurations described in connection with FIGS. 1-4 in various embodiments.

Further aspects of the present invention also relates to one or more of the following clauses. In various embodiments, the present disclosure describes hand-held devices with one or more touch-sensitive areas. The hand-held devices include a housing occupying each of a first plane, a second plane, and a third plane. A first exterior surface of the housing occupies the first plane and includes a first touch-sensitive area responsive to user touch. A second exterior surface of the housing occupies the second plane and includes a second touch-sensitive area responsive to user touch. A third exterior surface of the housing occupies the third plane and includes a display screen. A user interface module causes display of a user interface on the display screen and interprets at least one of (i) user touch of the first touch-sensitive area as a command to interact with the user interface or (ii) user touch of the second touch-sensitive area as a command to interact with the user interface.

In some embodiments, the user interface module is further configured to (i) based at least on user touch of at least one of the first touch-sensitive area or the second touch-sensitive area, determine how the hand-held device is being held, and (ii) based on how the hand-held device is being held, adjust the display of the user interface on the display screen. In these embodiments, the user interface module is further configured to interpret simultaneous user touch of the first touch-sensitive area and the second touch-sensitive area as the command to interact with the user interface.

In some embodiments, the user interface module is further configured to determine, based on the user touch of both the first touch-sensitive area and the second touch-sensitive area, a number of digits touching one of the first touch-sensitive area or the second touch-sensitive area. Based at least on the number of digits placed on one of (i) the first touch-sensitive area or (ii) the second touch-sensitive area, the user interface module is further configured to interpret the user touch of at least one of the first touch-sensitive area and the second touch-sensitive area as the command to manipulate the user interface.

In some embodiments, the manipulation of the user interface is at least one of a scroll action, magnification of the user interface, display of a menu, text entry, selection of a hot key, or an unlock of the hand-held device.

In some embodiments, the first touch-sensitive area is a touch pad and the first exterior surface is a physically opposite exterior surface from the third exterior surface that includes the display screen.

In some embodiments, the first touch-sensitive area is a touch pad, the first exterior surface is a physically opposite exterior surface from the third exterior surface, and the user interface module is further configured to display a cursor control associated with the touch pad within the user interface.

In some embodiments, the display screen is a touch-sensitive display screen. In some embodiments, the command to interact with the user interface is a user-programmed command. In some embodiments, the user interface module is further configured to enable—upon detecting the user touch of the second touch-sensitive area—the interpretation of the user touch of the first touch-sensitive area as the command.

In various embodiments, the present disclosure describes methods of operating a device with one or more touch-sensitive controls. The method includes detecting touch of a first touch-sensitive control that occupies a first plane of a housing of a hand-held device, detecting touch of a second touch-sensitive control that occupies a second plane of the housing of the hand-held device, and causing display of a user interface on a display screen occupying a third plane of the housing of the hand-held device. The method further includes interpreting at least one of (i) the touch of the first touch-sensitive control as a command to perform a user input function of the user interface displayed on the display screen or (ii) the touch of the second touch-sensitive control as a command to perform a user input function of the user interface displayed on the display screen.

In some embodiments, the user input function is enabled based at least on how the hand-held device is being held. In some embodiments, the touch of the second touch-sensitive area is interpreted as the command, and the method further comprises, in response to detection of the touch of the first touch-sensitive area, enabling the interpretation of the touch of the second touch-sensitive area as the command to perform the user input function.

In some embodiments, the methods further comprise determining a number of touches of the first touch-sensitive control and—based at least on the number of touches of the first touch-sensitive control—enabling of the user input function. In some embodiments, the methods further comprise based at least on the touch of the first touch-sensitive area, determining how the hand-held device is being held and based on how the hand-held device is being held, adjusting display of the user interface.

In various embodiments, the present disclosure describes methods of operating a device with touch-sensitive areas on a back surface. The method includes causing display of a user interface on a touch-sensitive display screen that is disposed on a front of a housing of a hand-held device, and interpreting user touch on a first touch-sensitive area disposed on a back of the housing of the hand-held device as a first command to manipulate a cursor control of the user interface. The back of the hand-held device is opposite to the front of the hand-held device.

In some embodiments, the first touch-sensitive display area is a touch pad, and the method further comprises, in response to touch of the first touch-sensitive element, changing a location of the cursor control within the user interface. In some embodiments, the methods further comprise—based on touch of a second touch-sensitive area—enabling interpretation of the touch of the first touch-sensitive area as the first command; the second touch-sensitive area is disposed on one of a side, top, or bottom of the hand-held device.

In some embodiments, the methods further comprise interpreting simultaneous user touch of the first touch-sensitive area and a second touch-sensitive area as a second command to manipulate the user interface; the second touch-sensitive area is disposed on one of a side, top, or bottom of the hand-held device.

In some embodiments, the methods further comprise—based on how the hand-held device is being held—enabling interpretation of the touch of the first touch-sensitive area as the first command.

For the purposes of the present disclosure, the phrase “A and/or B” means “(A), (B), or (A and B).” For the purposes of the present disclosure, the phrase “at least one of A, B, and C” means “(A), (B), (C), (A and B), (A and C), (B and C), or (A, B and C).”

The description uses the phrases “in an embodiment,” “in embodiments,” or similar language, which may each refer to one or more of the same or different embodiments. Furthermore, the terms “comprising,” “including,” “having,” and the like, as used with respect to embodiments of the present disclosure, are synonymous.

Although certain embodiments have been illustrated and described herein, a wide variety of alternate and/or equivalent embodiments or implementations calculated to achieve the same purposes may be substituted for the embodiments illustrated and described without departing from the scope of the present disclosure. This disclosure is intended to cover any adaptations or variations of the embodiments discussed herein. Therefore, it is intended that embodiments described herein be limited only by the claims and the equivalents thereof.

What is claimed is:

1. A hand-held device, comprising:
a housing occupying each of a first plane, a second plane, and a third plane, wherein
(i) a first exterior surface of the housing occupying the first plane includes a first touch-sensitive area that is responsive to user touch;
(ii) a second exterior surface of the housing occupying the second plane includes a second touch-sensitive area that is responsive to user touch;
(iii) a third exterior surface of the housing occupying the third plane includes a display screen; and
a user interface module configured to cause display a user interface on the display screen, wherein the user interface module is further configured to interpret at least one of (i) user touch of the first touch-sensitive area as a command to interact with the user interface or (ii) user touch of the second touch-sensitive area as a command to interact with the user interface.

2. The hand-held device of claim 1, wherein the user interface module is further configured to (i) based at least on user touch of at least one of the first touch-sensitive area or the second touch-sensitive area, determine how the hand-held device is being held, and (ii) based on how the hand-held device is being held, adjust the display of the user interface on the display screen.

3. The hand-held device of claim 1, wherein the user interface module is further configured to interpret simultaneous user touch of the first touch-sensitive area and the second touch-sensitive area as the command to interact with the user interface.

4. The hand-held device of claim 1, wherein the user interface module is further configured to:
determine, based on the user touch of both the first touch-sensitive area and the second touch-sensitive area, a number of digits touching one of the first touch-sensitive area or the second touch-sensitive area; and
based at least on the number of digits placed on one of (i) the first touch-sensitive area or (ii) the second touch-sensitive area, interpret the user touch of at least one of the first touch-sensitive area and the second touch-sensitive area as the command to manipulate the user interface.

5. The hand-held device of claim 1, wherein the manipulation of the user interface is at least one of a scroll action, magnification of the user interface, display of a menu, text entry, selection of a hot key, or an unlock of the hand-held device.

6. The hand-held device of claim 1, wherein:
the first touch-sensitive area is a touch pad; and
the first exterior surface is a physically opposite exterior surface from the third exterior surface that includes the display screen.

7. The hand-held device of claim 1, wherein:
the first touch-sensitive area is a touch pad;
the first exterior surface is a physically opposite exterior surface from the third exterior surface; and
the user interface module is further configured to display a cursor control associated with the touch pad within the user interface.

8. The hand-held device of claim 1, wherein the display screen is a touch-sensitive display screen.

9. The hand-held device of claim 1, wherein the command is a user-programmed command.

10. The hand-held device of claim 1, wherein the user interface module is further configured to enable the interpretation of the user touch of the first touch-sensitive area as the command upon detecting the user touch of the second touch-sensitive area.

11. A method comprising:
detecting touch of a first touch-sensitive control occupying a first plane of a housing of a hand-held device;
detecting touch of a second touch-sensitive control occupying a second plane of the housing of the hand-held device;
causing display of a user interface on a display screen occupying a third plane of the housing of the hand-held device; and
interpreting at least one of (i) the touch of the first touch-sensitive control as a command to perform a user input function of the user interface displayed on the display screen or (ii) the touch of the second touch-sensitive control as a command to perform a user input function of the user interface displayed on the display screen.

12. The method of claim 11, further comprising:
based at least on how the hand-held device is being held, enabling the user input function.

13. The method of claim 11, wherein:
the touch of the second touch-sensitive area is interpreted as the command; and
the method further comprises, in response to detection of the touch of the first touch-sensitive area, enabling the interpretation of the touch of the second touch-sensitive area as the command to perform the user input function.

14. The method of claim 11, further comprising:
determining a number of touches of the first touch-sensitive control; and
based at least on the number of touches of the first touch-sensitive control, enabling of the user input function.

15. The method of claim 11, further comprising:
based at least on the touch of the first touch-sensitive area, determining how the hand-held device is being held; and
based on how the hand-held device is being held, adjusting display of the user interface.

16. A method comprising:
causing display of a user interface on a touch-sensitive display screen disposed on a front of a housing of a hand-held device; and
interpreting user touch on a first touch-sensitive area disposed on a back of the housing of the hand-held device as a first command to manipulate a cursor control of the user interface, wherein the back of the hand-held device is opposite to the front of the hand-held device.

17. The method of claim 16, wherein:
the first touch-sensitive display area is a touch pad; and
the method further comprises, in response to touch of the first touch-sensitive element, changing location of the cursor control within the user interface.

18. The method of claim 16, further comprising:
based on touch of a second touch-sensitive area, enabling interpretation of the touch of the first touch-sensitive area as the first command,
wherein the second touch-sensitive area is disposed on one of a side, top, or bottom of the hand-held device.

19. The method of claim 16, further comprising;
interpreting simultaneous user touch of the first touch-sensitive area and a second touch-sensitive area as a second command to manipulate the user interface,
wherein the second touch-sensitive area is disposed on one of a side, top, or bottom of the hand-held device.

20. The method of claim 16, further comprising:
based on how the hand-held device is being held, enabling interpretation of the touch of the first touch-sensitive area as the first command.
